(19) United States
(12) Patent Application Publication
(10) Pub. No.: US 2007/0137267 A1
(43) Pub. Date: Jun. 21, 2007

(54) Lock set to deadbolt interlock

(75) Inventors: Edward J. Pilatowicz, Yorba Linda, CA (US); Gerald B. Chong, Rowland Heights, CA (US)

Correspondence Address: CARLSON, GASKEY & OLDS, P.C., 400 WEST MAPLE ROAD, SUITE 350, BIRMINGHAM, MI, 48009, US

(73) Assignee: Newfrey LLC

(21) Appl. No.: 11/305,417

(22) Filed: Dec. 16, 2005

(51) Int. Cl. E05B 59/00; E05B 49/00; E05B 63/14

(52) U.S. Cl. 70/107; 70/278.1

(57) ABSTRACT

An interlock is provided such that when a standard door lock handle is actuated, it will also open a deadbolt. The interlock is normally in a non-operational position. When a biometric sensor senses that a user wishing to use the door is approved, the interlock is actuated. The use of the interlock saves user movement by allowing the deadbolt to be opened with simple actuation of the standard lock structure.

### BACKGROUND OF THE INVENTION

This application relates to the use of a biometric sensor that actuates an interlock between a door lock set and a deadbolt such that the deadbolt can be opened along with a standard door lock when a handle is turned.

Entry doors to and from buildings are often provided with more than one lock. There is often a standard lock set which is actuated by a key from the outside of the building, and by a push button/turn knob/etc. from the inside of the building to lock and unlock.

Doors are often also provided with a deadbolt. A deadbolt is also provided with a key lock on the outside, and some form of locking actuation turn pin/lever/button/etc. on the inside.

It is typically the case that both the door lock and the deadbolt must be separately opened when the deadbolt is in a locked position, and one wishes to enter or leave a building. Thus, when the deadbolt is locked, a user wishing to use the door must separately turn the lever for the standard lock set, and also unlock the deadbolt in some manner. As one problem, a user must thus be outside the building for a relatively long period of time.

Biometric sensors are known in the lock industry. A biometric sensor is a sensor that has been programmed to remember an individual characteristic of an authorized user for the building. For example, a resident of a home may have a fingerprint stored within the biometric control system. The user moves a finger across the sensor, and the sensor transmits the sensed fingerprint to a control. The control compares the sensed fingerprint to a stored fingerprint, and may allow access into the building if the sensed fingerprint matches the stored fingerprint. Biometric sensors provide a higher level of security than normal locks in that with a normal lock, an intruder could copy or steal the key.

It would be desirable to simplify the entry into a building, and the biometric sensors do provide additional security that can facilitate simplification.

### SUMMARY OF THE INVENTION

In a disclosed embodiment of this invention, a biometric sensor senses characteristics of a user. If sensed characteristics match a stored characteristic, then a control recognizes that the user is authorized. An interlock is then actuated such that when the standard door handle is turned, the interlock also unlocks the deadbolt. Both the standard lock set and the deadbolt can now be opened by simply actuating the standard door handle. In this manner, entry or exit of the building is made simpler. Also, a user can enter the building more quickly due to the inventive interlock, providing increased safety.

In the disclosed embodiment, an interlock cam is normally out of position relative to an actuation structure for the deadbolt. The interlock cam turns with the door handle. However, unless the biometric sensor has sensed an approved individual, the interlock cam is out of line with the actuation structure. Thus, in this position, turning of the handle will not actuate the deadbolt actuation structure.

When an approved user is sensed, a force is applied to move the interlock cam into alignment with the deadbolt actuation structure. At this point, when the door handle is turned, it will actuate the deadbolt actuation structure, and the deadbolt will be opened, or closed.

These and other features of the present invention can be best understood from the following specification and drawings, the following of which is a brief description.

### BRIEF DESCRIPTION OF THE DRAWINGS

FIG. 1A is a view of an outer face of a door.

FIG. 1B shows a detail of the FIG. 1A door.

FIG. 2 is an exploded view of the inventive door lock assembly.

FIG. 3A is a front view of the assembled interlock in an unactuated position.

FIG. 3B shows an unbiased position for an interlock cam.

FIG. 3C shows an interlock cam having been moved to its biased position.

FIG. 4 shows a first position when the cam is in its biased position.

FIG. 5 shows the interlock cam having turned in a first direction.

FIG. 6 shows the interlock cam having turned in a second direction.

### DETAILED DESCRIPTION OF THE PREFERRED EMBODIMENT

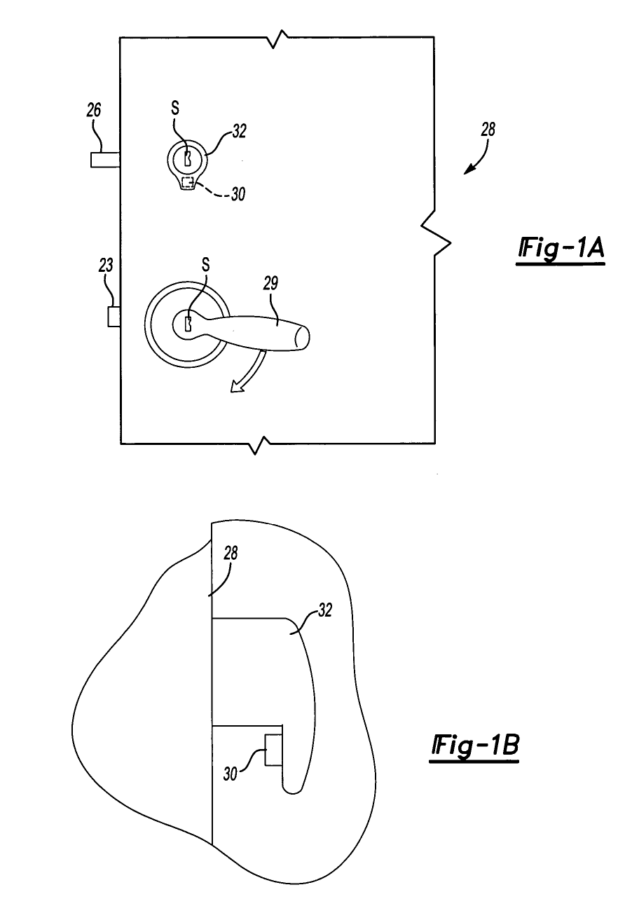

FIG. 1A shows a door 20 having a standard handle 29 for turning a lock 23. A deadbolt 32 controls a deadbolt lock 26. As is known, key slots S receive a key to lock or unlock the locks 23 and 26 from an outer face of the door. It should be understood that any type of actuation structure would come within the scope of this invention, as would any type of door handle. Thus, while the illustrated lever 29 is a turning lever, the present invention would extend to other types of door handles, including thumb latch, etc.

FIG 1B shows a detail of outer face 28 of the door. As shown, deadbolt cover 32 has a sensor 30 behind an extension.

Biometric sensor 30 may be as known, and is operable to sense some characteristic of a user of the door. Biometric sensors are known that sense fingerprints, voice, or other individual characteristics that are tied to an approved user of the door. Thus, a resident of a building can store a fingerprint, voice, etc. The present invention is not tied to any particular biometric sensor type, although in a preferred embodiment, a fingerprint recognition sensor is utilized. The present invention is directed to an interlock that allows turning of a handle 29 to actuate both locks 23 and 26 when an approved user has been sensed by the sensor 30.

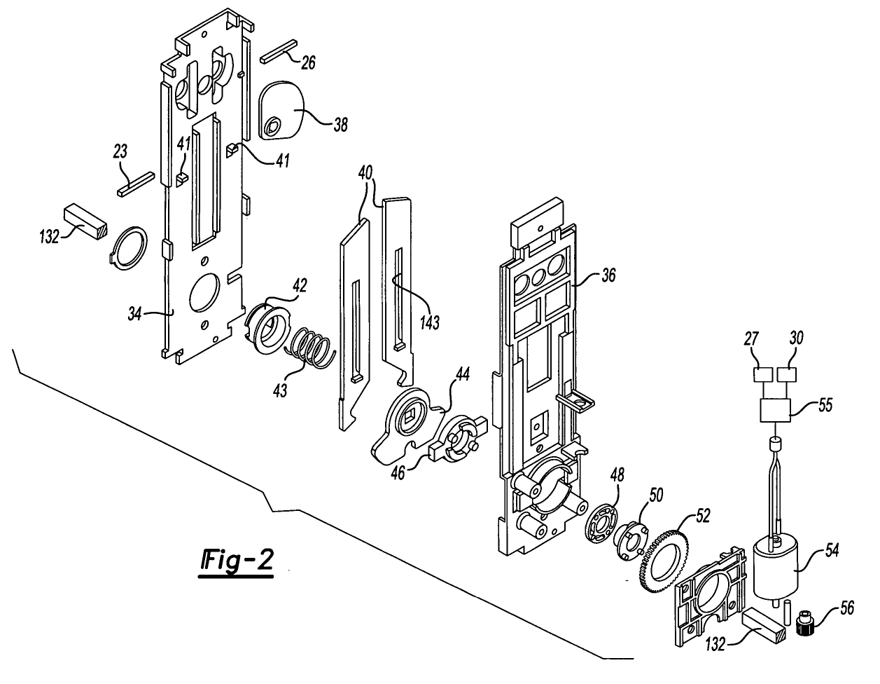

As shown in FIG. 2, lock actuation structure 132 turns with the handle 29 and with an inner handle (not shown). This aspect of the invention is as known, and is shown schematically. Further, the actuation of the lock 23 by the structure 132 is also illustrated schematically.

Plates 34 and 36 mount hardware as will be disclosed below.

A deadbolt cam 38 turns as will be explained to actuate the deadbolt 26. The transmission between deadbolt cam 38 and the deadbolt 26 is shown schematically, and may be as known. The deadbolt cam can be turned by a key in the key slot S or by an inner turn pin. The present invention also discloses an interlock such that when the structure 132 turns under some conditions, the deadbolt cam 38 will also turn.

The deadbolt interlock structure includes slides 40. As shown, a slot 143 in the slides 40 is guided along a tooth 41 on the plate 34. Thus, the movement of the slides is guided to be linear, and is limited at an extreme end of travel by the tooth. An insert 42 receives a spring 43. An interlock cam 44 is positioned adjacent an actuator 46. A clutch 48 and a driver 50 are associated with a gear 52. A motor 54 drives a worm 56 to turn the gear 52 under certain conditions as will be explained below. As shown, the motor 54 is controlled by a control 55. Control 55 receives signals from the sensor 30.

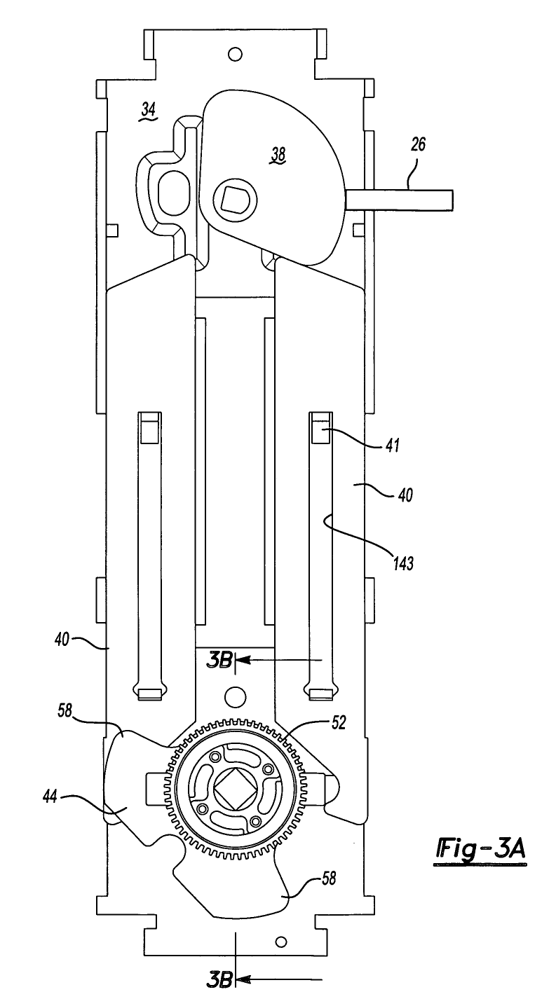

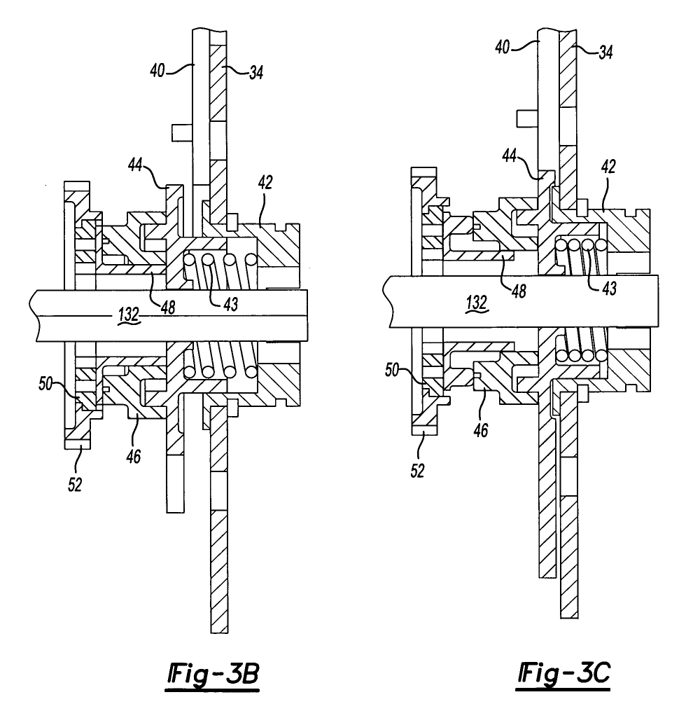

FIG. 3A shows a first unactuated position of the interlock assembly. This position is also shown in FIG. 3B. As shown, the interlock cam 44 is spaced beyond the slides 40 relative to the plate 34. Spring 43 has biased the interlock cam 44 to this position. As can be appreciated from both FIGS. 3A and 3B, the interlock cam 44 thus is not aligned with the slides 40, and if it is turned as shown in FIG. 3A, it will not contact or move the slides 40. With this movement, opening the lock 23 will not unlock deadbolt 26. As shown, ears 58 are formed at two circumferential ends of the interlock cam 44.

FIG. 3C shows movement after the application of force to the interlock cam 44 such that it is now forced against the spring 43 to be aligned with the slides 40. The present invention is directed to actuating this movement when a sensor 30 has sensed an approved occupant. Thus, a user of the door shown in FIGS. 1A or 1B will swipe a fingerprint (or otherwise actuate a biometric sensor). If the control 55 identifies the user as an approved user, then the motor 54 turns to drive worm 56, to subsequently turn gear 52. As gear 52 turns, the actuator 46 turns. Actuator 46 has a cam surface, which will force the interlock cam 44 against the spring force 43 to the FIG. 3C position. When in the FIG. 3C position, interlock movement as will be described below will occur. Otherwise, the interlock does not occur (FIGS. 3A and 3B) and turning handles 22 or 29 do not move the deadbolt. Of course, other mechanical transmission can be used to move the interlock cam 44.

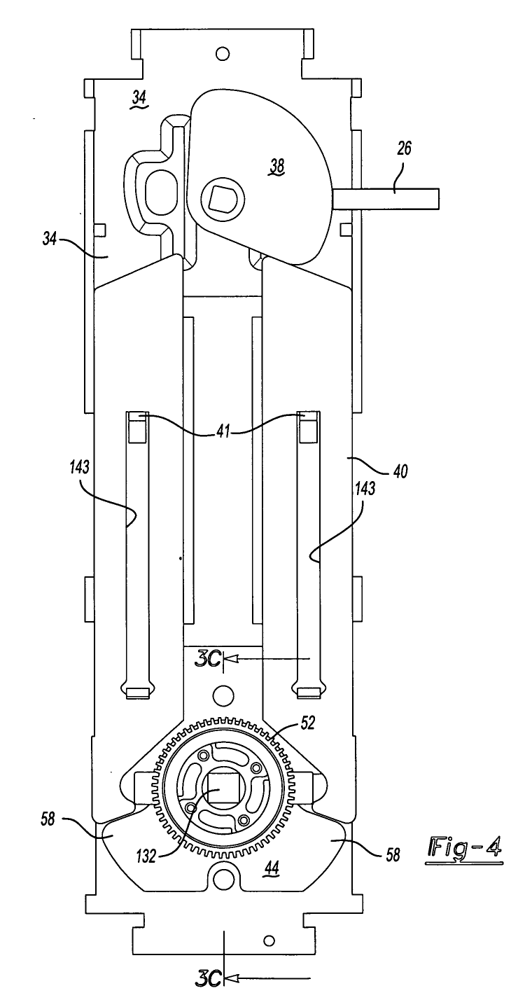

As shown in FIG. 4, the interlock cam 44 has now been forced towards the plate 34 such that it is aligned with the slides 40. However, the door handle has yet to be turned.

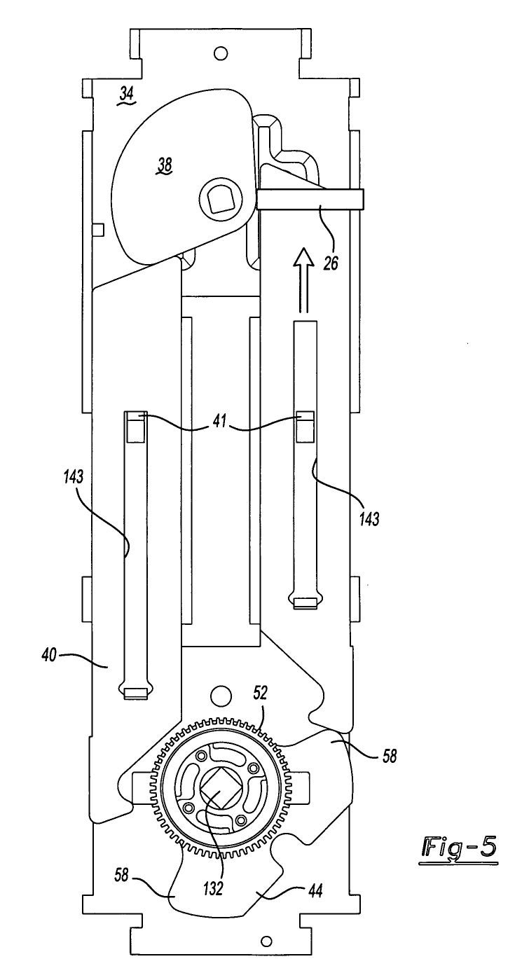

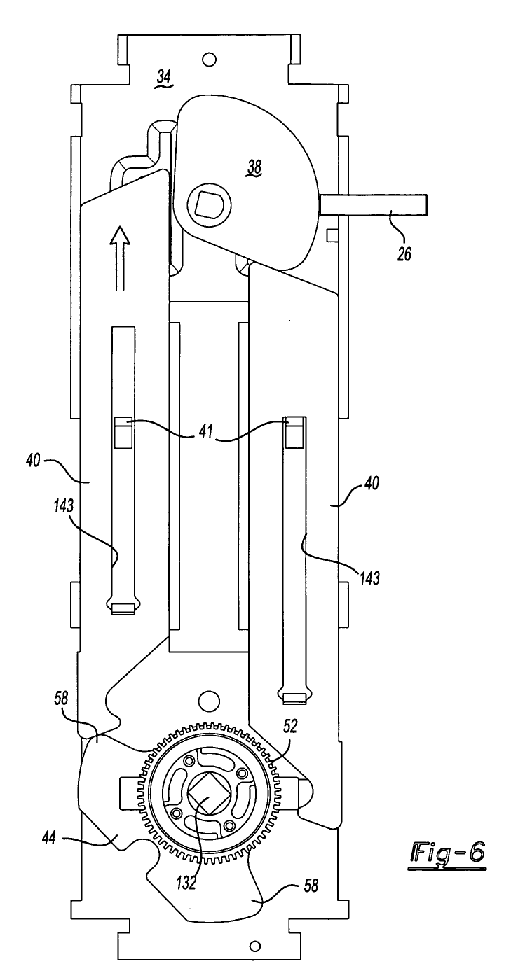

FIG. 5 shows a position wherein the door handle has been turned in one direction. When this occurs, the interlock cam 44 turns with the door handle, and the ear 58 forces the slide 40 upwardly on one side, actuating the deadbolt cam 38. The deadbolt 26 is shown schematically, and as mentioned previously, may operate as is known when the deadbolt cam 38 turns. FIG. 6 shows movement in the opposed direction.

The present invention thus allows a user to unlock or lock both door locks by only utilizing the handle as is typically associated with one of the locks. In this manner, the present invention thus simplifies the use of the door. Still, adequate security is provided because only authorized users are admitted. For purposes of this application, “handle” means levers, thumb latches or any other structure for actuating a lock.

While the interlock is shown only on the outer face, a similar interlock can be provided on the inner face by simply adding a second sensor.

Although a preferred embodiment of this invention has been disclosed, a worker of ordinary skill in this art would recognize that many modifications would come within the scope of this invention. For that reason, the following claims should be studied to determine the true scope and content of this invention.

What is claimed is:

1. A door lock arrangement comprising:
a deadbolt having a deadbolt latch, and a deadbolt cam for being turned to actuate said deadbolt latch;
a door lock set having a latch, and a handle to actuate said door lock latch;
a biometric sensor for sensing aspects of an individual wishing access to a building associated with said door lock arrangement, and a control comparing the sensed aspects with stored aspects to identify a user as an approved individual;
an interlock for selectively actuating said deadbolt latch when said handle is actuated under certain conditions; and
said interlock being moved to a position where it can actuate said deadbolt latch when said handle is actuated when said control senses that the individual is an approved individual.

2. The arrangement as set forth in claim 1, wherein said deadbolt and said door lock set have outer actuation structures for being an outer face of a door, and said interlock works for actuation of the handle on said outer face.

3. The arrangement as set forth in claim 1, wherein said biometric sensor recognizes a fingerprint.

4. The arrangement as set forth in claim 1, wherein an interlock cam is normally out of alignment with an actuation structure for actuating said interlock, and said interlock cam being moved to be aligned with said actuation structure when the control senses an approved individual.

5. The arrangement as set forth in claim 4, wherein a spring normally biases said interlock cam to be out of alignment with the actuation structure, and a motor turns a structure to drive said interlock cam against the spring force when an approved individual is identified.

6. The arrangement as set forth in claim 5, wherein a worm gear drives a gear to in turn actuate a ramped cam to force the interlock cam to the aligned position when an approved individual is identified.

7. The arrangement as set forth in claim 4, wherein said actuation structure includes a pair of slide elements that are selectively driven by said interlock cam.

8. The arrangement as set forth in claim 7, wherein said interlock cam drives one of said slide elements dependent on a direction of turning movement.

9. The arrangement as set forth in claim 8, wherein said slide elements actuate the deadbolt cam.

10. An interlock structure for selectively interlocking a door lock set with a deadbolt such that actuation of a handle for the door lock set will also actuate the deadbolt comprising:
an interlock actuation structure for selectively actuating a deadbolt cam when a lock handle is turned; and
an interlock cam for selectively actuating said interlock structure, said interlock cam being in a first position when an approved individual has not been identified by a biometric sensor associated with the interlock structure, said interlock cam not actuating said interlock actuation structure when in said first position, and said interlock cam being movable to a second position at which it will actuate the interlock actuation structure, said interlock cam being driven to the second position when an approved individual has been identified such that turning movement of the handle will actuate the deadbolt.

11. The structure as set forth in claim 10, wherein said interlock structure works for actuation by a handle on an outer face of a door.

12. The structure as set forth in claim 10, wherein a spring normally biases said interlock cam to be out of alignment with the interlock actuation structure and in said first position, and a motor turns a structure to drive said interlock cam against the spring force when an approved individual is identified.

13. The structure as set forth in claim 12, wherein a worm gear drives a gear to in turn actuate a ramped cam to force the interlock cam to the first position when an approved individual is identified.

14. The structure as set forth in claim 10, wherein said interlock structure includes a pair of slide elements that are selectively driven by said interlock cam.

15. The structure as set forth in claim 14, wherein said interlock cam drives one of said slide elements dependent on a direction of turning movement.

16. The structure as set forth in claim 15, wherein said slide elements actuate a deadbolt cam.
